(19) United States
(12) Patent Application Publication
(10) Pub. No.: US 2008/0290138 A1
(43) Pub. Date: Nov. 27, 2008

(54) Method for bonding refractory ceramic and metal

(76) Inventors: David Myron Lineman, Painted Post, NY (US); Wenchao Wang, Ithaca, NY (US)

Correspondence Address: CORNING INCORPORATED, SP-TI-3-1, CORNING, NY, 14831, US

(21) Appl. No.: 11/805,081

(22) Filed: May 22, 2007

(51) Int. Cl. B23K 31/00

(52) U.S. Cl. 228/122.1

(57) ABSTRACT

A method is disclosed for mechanically bonding a metal component to a ceramic material, comprising attaching an anchor material to at least a portion of one surface of the metal component, and then applying the ceramic material to at least a portion of the one surface of the metal component, such that after the ceramic material solidifies, the anchor material is substantially embedded in at least a portion of the ceramic material, thereby forming a mechanical bond between the metal component and the ceramic material via the anchor material. Also disclosed is an article comprising a metal component and a ceramic material mechanically bonded thereto through an anchor material attached to at least a portion of the metal component.

### BACKGROUND OF THE INVENTION

1. Field of the Invention

The present invention relates to refractory ceramics and specifically, to refractory ceramics for use in glass forming and/or delivery systems.

2. Technical Background

The fusion process is one of the basic techniques used to produce sheet glass and can produce sheet glass having surfaces with superior flatness and smoothness relative to sheet glass produced by alternative processes, such as for example, the float and slot drawn processes. As a result, the fusion process has found advantageous use in the production of the glass substrates used in the manufacture of light emitting displays, such as liquid crystal displays (LCDs).

The fusion process, specifically, the overflow downdraw fusion process, includes a glass supply pipe which provides molten glass to a collection trough formed in a refractory body known as an isopipe. During the overflow downdraw fusion process, molten glass passes from the supply pipe to the trough and then overflows the top of the trough on both sides, thus forming two sheets of glass that flow downward and then inward along the outer surfaces of the isopipe.

Surfaces of a glass forming and/or delivery system that are in contact with molten glass are typically comprised of a precious metal, such as platinum. The stability of the glass supply pipe and other components can be dependent upon the materials and techniques of construction. When subjected to operating temperatures of 1,000° C. or more, conventional materials can sag, creep, and/or deform, resulting in system and/or component failure.

There is a need to address the aforementioned problems and other shortcomings associated with glass forming and/or delivery systems and the traditional approaches for producing components for glass forming and/or delivery systems. These needs and other needs are satisfied by the methods and articles of the present invention.

### SUMMARY OF THE INVENTION

The present invention relates to refractory ceramics and specifically, to refractory ceramics for use in glass forming and/or delivery systems.

In a first aspect, the present invention provides a method for mechanically bonding a metal component to a ceramic material comprising attaching an anchor material to at least a portion of one surface of the metal component; and then applying the ceramic material to at least a portion of the first portion of the one surface of the metal component, such that after the ceramic material solidifies, the anchor material is substantially embedded in at least a portion of the ceramic material, thereby forming a mechanical bond between the metal component and the ceramic material via the anchor material.

In a second aspect, the present invention provides an article produced by the method described above.

In a third aspect, the present invention provides an article comprising a metal component, an anchor material attached to at least a portion of the metal component, and a ceramic material positioned on at least a portion of an exterior surface of the metal component and in contact with at least a portion of the anchor material, wherein at least a portion of the anchor material is substantially embedded in at least a portion of the ceramic material.

Additional aspects and advantages of the invention will be set forth, in part, in the detailed description, figures, and any claims which follow, and in part will be derived from the detailed description or can be learned by practice of the invention. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain aspects of the present invention and together with the description, serve to explain, without limitation, the principles of the invention. Like numbers represent the same elements throughout the figures.

FIGS. 1A & 1B are illustrations of ceramic materials bonded to metal components that incorporate an anchor material. FIG. 1A illustrates the use of a plurality of metal particles, in accordance with various aspects of the present invention. FIG. 1B illustrates the use of a metal mesh, in accordance with various aspects of the present invention.

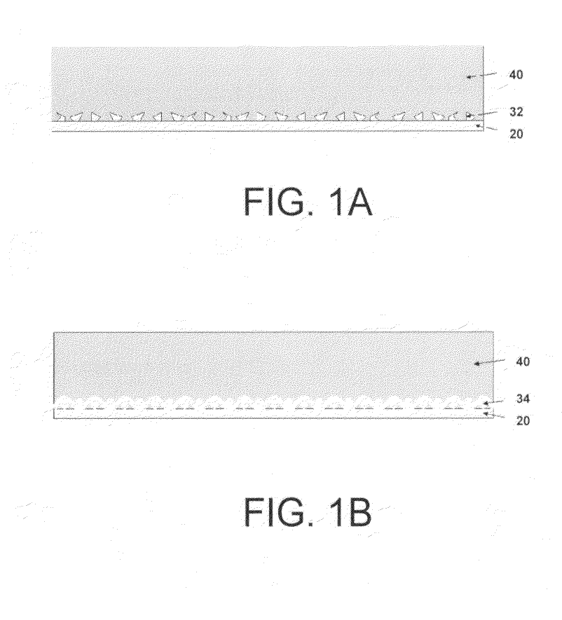

FIG. 2 is an illustration of a cross-section of a platinum glass delivery pipe coated with alternating layers of ceramic and oxygen impermeable barrier layers, in accordance with various aspects of the present invention.

### DETAILED DESCRIPTION OF THE INVENTION

The present invention can be understood more readily by reference to the following detailed description, drawings, examples, and claims, and their previous and following description. However, before the present compositions, articles, devices, and methods are disclosed and described, it is to be understood that this invention is not limited to the specific compositions, articles, devices, and methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its currently known embodiments. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F and an example of a combination embodiment, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “component” includes aspects having two or more such components, unless the context clearly indicates otherwise.

“Optional” or “optionally” means that the subsequently described event or circumstance can or cannot occur, and that the description includes instances where the event or circumstance occurs and instances where it does not. For example, the phrase “optionally substituted component” means that the component can or can not be substituted and that the description includes both unsubstituted and substituted aspects of the invention.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, refers to the ratio of the weight of the component to the total weight of the composition in which the component is included, expressed as a percentage.

As briefly introduced above, the present invention provides a method for mechanically bonding a metal component and a ceramic material, such as, for example, in a delivery pipe of a glass forming system. Among other aspects described in detail below and with reference to the figures, the inventive method comprises the use of a metal component 20, a ceramic material 40, and an anchor material, such as, for example, a metal mesh 34 or a plurality of metal particles 32, to provide a mechanically strong bond between the metal component 20 and the ceramic material 40.

While the methods of the present invention are not intended to be limited to a particular application, they can be used to reduce and/or eliminate sag of components in a glass forming and/or delivery system. Conventional materials used in a glass forming and/or delivery system can sag substantially during use because the mechanical strength at operating temperatures is typically not sufficient to support the weight of the components themselves. The present invention provides methods to improve the strength and durability of glass forming and/or delivery components by employing anchor materials to help bond the ceramic material to a metal component.

The present invention provides a novel approach to mechanically bond a ceramic material with a metal. The invention provides a method for attaching an anchor material to a metal component, and then applying a ceramic material positioned on or around the metal component. The ceramic material can provide support to a metal component, thereby extending the useful life of the metal component. Use of the ceramic support material can also provide structural support to the metal component, allowing a thinner metal component. In applications, such as glass forming systems, where the metal component comprises a precious metal, use of a thinner metal component can result in significant cost savings.

### Metal Component

The metal component of the present invention can be any component suitable for mechanically bonding to a ceramic material. While the aspects described herein are related to a glass forming and/or delivery system, the present invention can be useful in any application where a metal component can be mechanically bonded to a ceramic material and the present invention is not intended to be limited to glass forming and/or delivery systems. The metal component, in one aspect, is a metal component that will deform under exposure to high temperatures, such as those typical in a glass forming system. In one aspect, the metal component is a portion of a glass forming system. In a specific aspect, the metal component is a metal portion of a glass delivery pipe. In another aspect, the metal component is a component, such as a sheet, that can be fabricated into a portion of a glass forming and/or delivery system. The specific dimensions and/or geometry of a metal component can vary depending on the intended application. In one aspect, a metal component can be from about 0.010 inches thick to about 0.125 inches thick, or greater, for example, about 0.01, 0.015, 0.02, 0.025, 0.03, 0.035, 0.04, 0.05, 0.06, 0.08, 0.9, 0.1, or 0.125 inches thick. In one specific aspect, the metal component can be about 0.040 inches thick. In another aspect, the metal component can be about 0.010 inches thick. In other various aspects, the metal component can be thinner than 0.010 inches or thicker than 0.125 inches thick and the present invention is not intended to be limited to a particular thickness. It should be understood that the thickness of one or more metal components can vary and that the thickness of any individual metal component can be different at various portions of the metal component.

The metal component of the present invention can comprise any metal suitable for use in the intended application, such as, for example, a glass forming system. In various aspects, the metal component can comprise at least one noble metal and/or noble metal alloy, at least one platinum group metal and/or platinum group metal alloy, or a combination thereof. In one aspect, the metal component comprises a noble metal, such as gold, silver, tantalum, platinum, palladium, or rhodium. In another aspect, the metal component comprises a platinum group metal, such as, ruthenium, rhodium, platinum, palladium, osmium, or iridium. In another aspect, the metal component can comprise at least one refractory metal, such as, for example, tungsten, molybdenum, niobium, tantalum, rhenium, and alloys thereof. In various specific aspects, the metal component comprises platinum and/or a platinum/rhodium alloy, such as a 90/10 wt. % or 80/20 wt. % platinum/rhodium alloy. Metal components and materials for fabrication of metal components are commercially available and one of skill in the art could readily select an appropriate metal component.

### Anchor Material

The anchor material of the present invention can be attached to at least a portion of the metal component and can provide a surface that can form a mechanical bond with at least a portion of a ceramic material. The anchor material of the present invention can be any material suitable for use in a metal/ceramic bonded application and that is capable of attaching to a metal component. The anchor material can comprise any geometry capable of attaching to a metal component and forming a mechanical bond with a ceramic material attached thereto. In one aspect, the anchor material is embedded and/or interlocked with at least a portion of the ceramic material. The anchor material can comprise, for example, a metal mesh, a plurality of metal particles, a sheet metal structure, or a combination thereof.

In one aspect, the anchor material is a mesh, such as a metal mesh. A metal mesh anchor material can have multiple openings through which a ceramic material can flow. The ceramic material can, in one aspect, fill at least a portion of the openings and solidify, forming a mechanical bond between the metal component and the solidified ceramic material. A metal mesh anchor material can comprise any metal mesh capable of attaching to the metal component and occluding at least a portion of a ceramic material. In various aspects, the metal mesh can have a mesh size of, for example, from about 3 mesh to about 80 mesh, for example, about 3, 4, 5, 8, 10, 12, 14, 18, 20, 22, 24, 28, 30, 36, 40, 44, 48, 50, 52, 56, 58, 60, 62, 64, 68, 70, 72, 74, 76, 78, or 80 mesh; from about 10 to about 40 mesh, for example, about 10, 12, 14, 18, 20, 22, 24 28, 30, 32, 34, 36, 38, or 40 mesh; or from about 10 to about 25 mesh, for example, 10, 12, 14, 18, 20, 22, 24, or 25 mesh. As used herein, the term “mesh size” is intended to refer to the number of openings per linear inch of a material. In one aspect, the metal mesh is a 20 mesh screen. In another aspect, the metal mesh is a 10 mesh screen. In various other aspects, the metal mesh can have a mesh size of less than 3 or greater than 80, and the present invention is not intended to be limited to a specific mesh size, provided that the metal mesh can allow a ceramic material to flow through and/or fill at least a portion of the mesh openings, solidify, and form a mechanical bond. In one aspect, the anchor material is capable of being embedded or substantially embedded in at least a portion of a ceramic material.

In various aspects, a metal mesh can comprise a wire having a nominal diameter of, for example, from about 0.003 inches to about 0.060 inches, for example, about 0.003, 0.006, 0.009, 0.012, 0.015, 0.018, 0.020, 0.025, 0.030, 0.036, 0.040, 0.044, 0.050, 0.058, or 0.060 inches; or from about 0.005 inches to about 0.020 inches, for example, about 0.005, 0.008, 0.010, 0.012, 0.018, or 0.020 inches. In one aspect, the metal mesh comprises a wire having a nominal diameter of 0.008 inches. In another aspect, the metal mesh comprises a wire having a nominal diameter of 0.010 inches. In various other aspects, the metal mesh can comprise a wire having a nominal diameter of less than 0.003 inches or greater than 0.020 inches, and the present invention is not intended to be limited to a specific wire diameter. A metal mesh can be, for example, woven, knitted, or other physical forms and the present invention is not limited to a particular form of metal mesh. In one aspect, the metal mesh is woven. The size of, for example, a metal mesh can vary depending upon the size and dimensions of the desired article and the properties (e.g., rheological properties) of a ceramic material, provided that the metal mesh can allow a ceramic material to flow through and/or fill at least a portion of the mesh openings, solidify, and form a mechanical bond. In one aspect, a metal mesh is capable of interlocking or embedding at least a portion of the ceramic material applied thereto. In another aspect, a metal mesh having a small mesh size is utilized when a castable fluid ceramic material having a viscosity sufficiently low to allow at least a portion of the ceramic material to flow through and/or fill at least a portion of the mesh openings is to be applied. In another aspect, a metal mesh having a large mesh size is utilized when a more viscous ceramic material is to be applied. The mesh size and wire diameter of a metal mesh can be selected to withstand a particular stress, for example, under operating conditions.

The anchor material of the present invention can comprise metal particles that can be attached to a metal component. The anchor material can comprise a plurality of metal particles dispersed on at least a portion of one surface of a metal component. The metal particles of an anchor material, if the anchor material comprises metal particles, can have regular, irregular and/or varying shapes. It is not necessary that the metal particles have a specific shape or that all metal particles have the same shape. It is preferred that at least a portion of the plurality of metal particles, if present, have a shape capable of mechanically bonding a ceramic material applied thereto. In one aspect, the plurality of metal particles are attached and positioned such that a ceramic material can flow around at least a portion of the plurality of metal particles and solidify, forming a mechanical bond. In another aspect, a plurality of metal particles can interlock or occlude a ceramic material applied thereto. In various aspect, the metal particles of an anchor material can have a diameter of, for example, from about 0.003 inches to about 0.060 inches, for example, about 0.003, 0.006, 0.009, 0.012, 0.015, 0.018, 0.020, 0.024, 0.030, 0.036, 0.040, 0.048, 0.050, 0.052, or 0.060 inches; or from about 0.008 to about 0.020 inches, for example, about 0.008, 0.012, 0.014, 0.016, 0.018, or 0.020 inches. In one aspect, the metal particles have a diameter of about 0.016 inches. In another aspect, the metal particles have a diameter of about 0.020 inches. In various other aspects, the metal particles can have a diameter smaller than 0.003 inches or greater than 0.020 inches. As used herein, the term “diameter” refers to a median diameter of, for example, a metal particle. It is understood that the size and shape of metal particles can vary and are typically distributional properties. In a distribution of, for example, particle sizes, the endpoints of the distribution range can be above, at, or below the ranges described above. Thus, in one aspect, the metal particles have a median diameter of about 0.020 inches and can range from about 0.015 inches to about 0.025 inches.

The anchor material of the present invention can comprise a sheet metal structure. A sheet metal structure can comprise, for example, a corrugated piece of metal or a formed piece of metal that can be attached to a metal component and can accept and interlock a ceramic material. In one aspect, a sheet metal structure is designed and positioned such that a ceramic material can flow through, around, and/or over at least a portion thereof and solidify, forming a mechanical bond.

The anchor material of the present invention can comprise any metal suitable for use in the intended application, such as, for example, a glass forming system. In various aspects, the anchor material can comprise at least one noble metal and/or noble metal alloy, at least one platinum group metal and/or platinum group metal alloy, at least one refractory metal and/or refractory metal alloy, or a combination thereof. In one aspect, the anchor material comprises a noble metal, such as gold, silver, tantalum, platinum, palladium, or rhodium. In another aspect, the anchor material comprises a platinum group metal, such as, ruthenium, rhodium, platinum, palladium, osmium, or iridium. In another aspect, the anchor material comprises a refractory metal, such as tungsten, molybdenum, niobium, tantalum, or rhenium. In various aspects, the anchor material comprises platinum and/or a platinum/rhodium alloy. In a specific aspect, the anchor material is platinum.

In another specific aspect, the anchor material is a platinum/rhodium (80/20) alloy. In yet another specific aspect, the anchor material is a platinum/rhodium (90/10) alloy. The anchor material can comprise an individual or multiple metals. Further, if the anchor material comprises multiple individual pieces, such as for example, a plurality of metal particles, one or more pieces of metal mesh, or a combination thereof, each individual piece can comprise either the same or differing compositions. The composition of a particular anchor material can be the same or different from the composition of a metal component, provided that the anchor material is capable of being attached to the metal component. In a specific aspect, the anchor material comprises a metal mesh having a 20 mesh screen size, a nominal wire diameter of about 0.008 inches, and is comprised of a platinum/rhodium (90/10) alloy. Anchor materials, such as, for example, platinum mesh and platinum particles, are commercially available (e.g., Alfa Aesar, Ward Hill, Massachusetts, USA) and one of skill in the art could readily select an appropriate anchor material.

### Attachment of Anchor Material

The anchor material of the present invention can be attached to at least a portion of one surface of metal component. It is not necessary that an anchor material completely cover a metal component as the anchor material need only be present in a quantity and position sufficient to form a mechanical bond with at least a portion of a ceramic material. In one aspect, the anchor material is attached to at least a portion of a metal component in a discontinuous fashion such that the anchor material is not present in a continuous layer.

The metal component, such as, for example, a platinum alloy sheet, can optionally be cleaned to remove oil and other surface contaminants and impurities prior to attachment. Such a cleaning step can be performed, for example, using conventional detergents, surfactants, and/or solvents.

The surface of a metal component can optionally be roughened prior to attachment using, for example, chemical and/or mechanical techniques. In one aspect, the surface of a metal component to which an anchor material is to be attached can be roughened by sand and/or bead blasting. In another aspect, the surface of a metal component to which an anchor material is to be attached can be roughened by a chemical etching technique. It is not necessary that a cleaning or roughening step be performed prior to attachment.

The anchor material of the present invention can be distributed on at least a portion of one surface of the metal component. In one aspect, the anchor material can be positioned in a plurality of discrete locations on at least a portion of a surface of the metal component. For example, an anchor material comprising a metal mesh can be a single piece of metal mesh or multiple pieces of metal mesh positioned on a surface of the metal component. Such a discrete placement of an anchor material can allow the underlying metal component to deform (e.g., buckle) as necessary to relieve stress that can result from, for example, differing thermal expansion coefficients of the ceramic, anchor material, and/or metal component. In one aspect, a piece of metal mesh can be cut to a size and shape that is similar to and/or matches the size and shape of a metal component. In another aspect, a piece of metal mesh can be smaller than a metal component. An anchor material comprised of metal particles can be distributed randomly, in a pattern, or in a uniform manner on a surface of the metal component. In one aspect, a metal particle anchor material is uniformly distributed across the portion of the metal component surface to which a ceramic material is to be applied. In another aspect, a metal particle anchor material can be distributed in a predetermined pattern to enhance bonding and thus, strength of a bonded article in particular high-stress regions.

After contacting an anchor material to a portion of a metal component, the anchor material can be attached using any suitable technique. In one aspect, the anchor material can be attached to a metal component by heating the metal component and anchor material at a time and temperature sufficient to fuse at least a portion of the anchor material to the metal component. It is not necessary that the anchor material completely fuse to the metal component so long as a sufficient quantity of anchor material is fused to allow bonding of a ceramic material. In various aspects, the contacted anchor material and metal component can be heated at a temperature of at least about 1,300° C., for example, 1,300, 1,400, 1,500, 1,600, 1,650, 1,700° C. or greater, for a period sufficient to attach at least a portion of the anchor material to at least a portion of the metal component, such as, at least about 0.25 hours, for example, about 0.25, 0.5, 0.75, 1, 2, 4, 6, 8, 10, 12, 16, or 24 hours; for at least about 2 hours, for example, about 2, 4, 6, 8, 10, 12, 16, or 24 hours, or for at least about 5 hours, for example, about 5, 6, 7, 8, 9, 10, 12, 14, 18, or 24 hours. The specific time and temperature of heating can vary. A shorter heating time, such as, for example, about 20 minutes, can be utilized if the temperature is sufficiently high to attach at least a portion of the anchor material to at least a portion of the metal component. In one aspect, the contacted anchor material and metal component is heated at about 1,650° C. for a period of about 2 hours. In another aspect, the contacted anchor material and metal component are heated at about 1,700° C. for a period of about 20 minutes. The anchor material and metal component can be heated at a higher temperature and/or for a longer period of time, provided that the increased heating does not adversely affect the materials and/or their ability to fuse and bond a ceramic material. The anchor material and metal component can be heated at a lower temperature and/or for a shorter period of time, provided that at least a portion of the anchor material can fuse to at least a portion of the metal component.

During heating, pressure, such as, for example, a compressive force, can optionally be applied to the anchor material and the metal component to enhance and/or speed the attachment process. The pressure applied, if any, can vary depending upon the specific materials and heating conditions. In one aspect, a pressure of at least about 1 psi is applied to the anchor material and metal component during heating. In another aspect, a pressure of at least about 10 psi is applied to the anchor material and metal component during heating.

Other techniques for attaching materials, such as, for example, welding and/or adhesive techniques, can be utilized provided that materials attached using such techniques are stable at temperatures to which the metal component will be exposed. One or more techniques can be used to attach an anchor material to a metal component. Metal fusing techniques are known in the art and one of skill in the art could readily select an appropriate technique and conditions for attaching an anchor material to a metal component.

If a metal component is not originally provided in a form or shape suitable for the intended application, it can optionally be formed into such a desired shape either prior to, simultaneous to, or subsequent to the attachment process. In one aspect, a platinum sheet is provided and is formed into a pipe prior to the attachment process. In another aspect, a platinum sheet is provided and is formed into a pipe after the attachment process.

### Ceramic Material

The ceramic material of the present invention can be any ceramic suitable for bonding to a metal component. The ceramic material can comprise a refractory oxide, such as, for example, ZrO₂, SiO₂, CaO, MgO, Al₂O₃, other refractory oxides, and/or mixtures thereof. As used herein, the term “ceramic” or “ceramic material” is intended to refer to a non-solidified ceramic material, such as, for example, a slurry or mixture of ceramic components, and is not intended to refer to a dried, hardened, fired, or otherwise solidified ceramic material unless specified as such. The ceramic material can comprise an individual or multiple ceramic materials of varying compositions, particle sizes, and phases. The ceramic material can also comprise additives and/or sintering aids. In one aspect, the ceramic material can comprise at least one additive to control and/or adjust the rheological properties, such as, for example, viscosity, of the ceramic material. In another aspect, the ceramic material is compatible with conventional glass forming and/or delivery systems. In various aspects, the ceramic material is capable of enduring temperatures typical of those in a glass forming and/or delivery system, for example, up to about 1,600, 1,650, or 1,700° C. or more. Ceramic materials are commercially available and one of skill in the art could readily select an appropriate ceramic material for use in a particular article and/or application.

### Application of Ceramic Material

The ceramic material of the present invention can be applied to the attached anchor material and metal component using any suitable technique. In one aspect, the ceramic material is applied such that at least a portion thereof flows through, around, and/or over at least a portion of the anchor material. In another aspect, the ceramic material is applied such that at least a portion of the attached anchor material is embedded or substantially embedded in at least a portion of the ceramic material. It is not necessary that an anchor material be completely embedded in a ceramic material, provided that one or more anchor materials are embedded to the extent necessary to mechanically bond a portion of the ceramic material to at least a portion of a metal component. In one aspect, at least one anchor material is completely embedded in a ceramic material. In another aspect, at least one anchor material is substantially embedded in a ceramic material, such that the anchor material interlocks with the ceramic material. In another aspect, a metal mesh anchor material has a least a portion of the mesh openings filled with the ceramic material. In yet another aspect, at least a portion of a plurality of metal particles are at least partially surrounded by at least a portion of the ceramic material.

The rheological properties of a ceramic material can be controlled and/or adjusted with additives such that at least a portion of the ceramic material can flow through, around, and/or over at least a portion of the anchor material. A ceramic material applied in such manner can be allowed to solidify or harden such that a mechanical bond is formed between the anchor material/metal component combination and the ceramic material.

In one aspect, the ceramic material is cast. The ceramic material can be cast onto at least a portion of one surface of the attached metal component/anchor material prior to assembly in, for example, a glass delivery system, or after assembly. In one aspect, an attached metal component/anchor material is formed into a glass delivery pipe and is positioned in the refractory enclosure of a conventional glass delivery system prior to casting a ceramic material around the pipe.

One or multiple ceramic materials can be applied to an attached metal component/anchor material. In one aspect, a single ceramic material is cast on or around an attached component. In another aspect, multiple ceramic materials of varying composition are cast on or around an attached component. A ceramic material can be applied to a portion of a surface of a metal component comprising an attached anchor material or to an entire surface of a metal component comprising an attached anchor material. In various other aspects, a ceramic material can be applied using a spraying technique, such as, for example, a flame spraying technique or a plasma spraying technique.

The ceramic material can be applied in any quantity and/or thickness suitable for the intended application. When used in a glass forming system, the ceramic material can be applied, in various aspects, to a thickness of, for example, from about 0.05 inches to about 0.5 inches or more, for example, about 0.05, 0.10, 0.125, 0.15, 0.2, 0.25, 0.3, 0.4, or 0.5 inches. In one aspect, the ceramic material is applied to a thickness of about 0.125 inches. Application techniques for ceramic materials are known and one of skill in the art could readily select an appropriate application technique for a ceramic material of the present invention.

After application, a ceramic material can be solidified. Such solidification can, in one aspect, comprise allowing the ceramic material to dry, harden, and/or cure without additional steps. In another aspect, solidification can comprise heating and/or firing the applied ceramic material. In one aspect, the applied ceramic material can have a green body strength sufficient for the intended application. In one aspect, the cast ceramic article can be dried for a period of from about 10 to about 48 hours prior to firing. In various further aspects, the ceramic article can subsequently be fired in a normal heat-up schedule for a glass forming system, in a furnace, or a combination thereof.

### Oxygen Impermeable Barrier

An article having a metal component, an anchor material, and a ceramic material, in accordance with the present invention, can further comprise a coating comprising an oxygen impermeable barrier layer. An oxygen impermeable barrier layer can reduce and/or prevent high temperature oxidation of a glass delivery system component, such as a delivery pipe. An oxygen impermeable barrier layer, if present, can coat a portion of the exterior surface of a bonded article or the entire surface of a bonded article.

An oxygen impermeable barrier layer can comprise any material suitable for providing a barrier layer. In various aspects, the barrier layer can comprise a glass and/or a glass-ceramic material. The thickness of an oxygen impermeable barrier layer can vary depending on the barrier layer composition and the intended application.

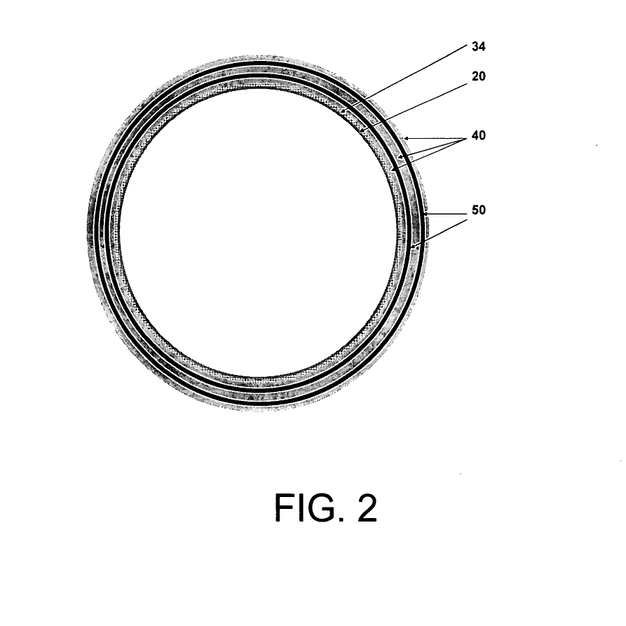

To improve strength and limit oxidation, an article having at least one oxygen impermeable barrier layer can further comprise additional layers of either a barrier material and/or a ceramic material. In one aspect, an article comprises a plurality of alternating layers, for example, 2, 3, 4, 5, or more layers, of an oxygen impermeable barrier layer and a ceramic material. In a specific aspect, as illustrated in FIG. 2, an anchor material 34 is attached to a metal component 20, to which a first layer of a ceramic material is applied 40, followed by four additional layers—two each of a ceramic layer 40 and an oxygen impermeable barrier layer 50 comprising a glass, in alternating fashion. The specific aspect illustrated in FIG. 2 is not intended to be limiting and the metal component, anchor material, ceramic and oxygen impermeable barrier layer materials can vary in, for example, composition, shape, and application method.

Although several aspects of the present invention have been illustrated in the accompanying drawings and described in the detailed description, it should be understood that the invention is not limited to the aspects disclosed, but is capable of numerous rearrangements, modifications and substitutions without departing from the spirit of the invention as set forth and defined by the following claims.

### EXAMPLES

To further illustrate the principles of the present invention, the following examples are put forth so as to provide those of ordinary skill in the art with a complete disclosure and description of how the methods and articles, devices claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations should be accounted for. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

### Example 1

### Attachment of Platinum Mesh to Platinum Plate

In a first example, a platinum/rhodium (90/10 wt. %) alloy 20 mesh screen having a nominal wire diameter of 0.008 inches was attached to a platinum plate. The piece of mesh was cut to approximately the same size as the platinum test plate and positioned on top of the platinum plate. The mesh/plate combination was then heated in a furnace at 1,650° C. for 10 hours, fusing the mesh to the plate.

### Example 2

### Preparation of Bonded Test Article

In a second example, a test article was prepared comprising a ceramic material and the platinum mesh/plate composition prepared in Example 1. The platinum mesh/plate composition prepared in Example 1 was positioned in a small rectangular box such that the mesh was on top. A ZrO₂ ceramic was cast in the box and on top of the mesh/plate composition to a thickness of 0.5 inch. The resulting combination was dried and sintered at about 1,650° C.

### Example 3

### Sag Resistance of Bonded Articles

In a third example, test articles were evaluated for sag resistance. The platinum/ZrO₂ bonded article prepared in Example 2 and a free-standing platinum plate not covered with an anchor or ceramic material were positioned across two arms of support blocks in a 1,450° C. furnace. In less than 24 hours, the free-standing platinum plate sagged, adopting the curved shape of the support block. In contrast, the platinum/ZrO₂ bonded article withstood at least 60 hours under similar conditions without sagging. These examples illustrate the increased strength and resistance to sag that can be achieved using the methods of the present invention.

Throughout this application, various publications are referenced. The disclosures of these publications in their entireties are hereby incorporated by reference into this application in order to more fully describe the compositions, articles, device, and methods described herein.

Various modifications and variations can be made to the compositions, articles, devices, and methods described herein. Other aspects of the compositions, articles, devices, and methods described herein will be apparent from consideration of the specification and practice of the compositions, articles, devices, and methods disclosed herein. It is intended that the specification and examples be considered as exemplary.

What is claimed is:

1. A method for mechanically bonding a metal component to a ceramic material, comprising:
a) attaching an anchor material to at least a first portion of one surface of the metal component; and then
b) applying the ceramic material to at least a portion of the first portion of the one surface of the metal component, such that after the ceramic material solidifies, the anchor material is substantially embedded in at least a portion of the ceramic material, thereby forming a mechanical bond between the metal component and the ceramic material via the anchor material.

2. The method of claim 1, wherein the metal component comprises a noble metal, a platinum group metal, a refractory metal, or a combination thereof.

3. The method of claim 1, wherein the metal component comprises platinum, a platinum alloy, or a combination thereof.

4. The method of claim 1, wherein the anchor material comprises at least one of:
a) a metal mesh, or
b) a plurality of metal particles.

5. The method of claim 4, wherein the anchor material comprises at least one of:
a) a metal mesh having a mesh size of from about 3 to about 80 mesh, or
b) a plurality of metal particles having a particle size of from about 0.003 inches to about 0.060 inches.

6. The method of claim 4 wherein the anchor material comprises a plurality of metal particles distributed on at least a portion of one surface of the metal component in a substantially uniform manner.

7. The method of claim 4, wherein the anchor material comprises platinum, a platinum alloy, or a combination thereof.

8. The method of claim 1, wherein the attaching comprises:
a) contacting the anchor material with the at least a portion of one surface of the metal component; and then
b) heating the contacted metal component and anchor material at a time and temperature sufficient to fuse at least a portion of the anchor material to the metal component.

9. The method of claim 8, wherein heating is at a temperature of at least about 1,300° C. for a period of from about 1 to about 24 hours.

10. The method of claim 1, further comprising forming the metal component to a desired shape after the attaching step and prior to the applying step.

11. The method of claim 10, wherein the desired shape comprises a glass delivery pipe having the anchor material attached to at least a portion of an exterior surface thereof.

12. The method of claim 1, wherein applying comprises a casting technique.

13. The method of claim 1, wherein the ceramic material comprises a refractory oxide.

14. The method of claim 1, further comprising firing the ceramic material after applying to a least a portion of the one surface of the metal component.

15. The method of claim 1, wherein the ceramic material is applied to a thickness of at least about 0.10 inch.

16. The method of claim 1, further comprising coating the ceramic material with an oxygen impermeable barrier layer.

17. The method of claim 16, wherein the oxygen impermeable barrier layer comprises a glass.

18. The method of claim 1, further comprising coating the ceramic material with a plurality of layers, wherein the layers comprise an oxygen impermeable barrier layer, a glass, a ceramic material, or a combination thereof.

19. An article comprising:
a) a metal component;
b) an anchor material attached to at least a portion of the metal component; and
c) a ceramic material positioned on at least a portion of an exterior surface of the metal component and in contact with at least a portion of the anchor material;
wherein at least a portion of the anchor material is substantially embedded in at least a portion of the ceramic material.

20. An article produced by the method of claim 1.
